(19) United States
(12) Patent Application Publication
(10) Pub. No.: US 2010/0087310 A1
(43) Pub. Date: Apr. 8, 2010

(54) Heptazine Modified Titanium Dioxide Photocatalyst and Method for Its Manufacture

(76) Inventors: Horst Kisch, Erlangen (DE); Dariusz Mitoraj, Erlangen (DE)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 12/570,212

(22) Filed: Sep. 30, 2009

(30) Foreign Application Priority Data
Oct. 2, 2008 (DE) DE 102008050133.6
Apr. 8, 2009 (DE) DE 102009017409.5

(51) Int. Cl. H01M 4/88; B01J 31/02

(52) U.S. Cl. 502/101; 502/167

(57) ABSTRACT

The invention is a heptazine modified photocatalyst based on titanium dioxide that is photoactive in the visible range, also referred to as TiO₂—(N═C)x below. The new photocatalyst permits pollutant degradation not only with artificial visible light but also with the diffuse daylight in rooms The invention also is a method for manufacturing a heptazine modified titanium dioxide (TiO₂—(N═C)ₓ) that is effective as a photocatalyst when irradiated with visible light.

### RELATED APPLICATION

This application claims priority to German patent application Serial Nos. DE 10 2008 050 133.6 filed Oct. 2, 2008 and DE 10 2009 017 409.5 filed Apr. 8, 2009.

### TECHNICAL FIELD OF THE INVENTION

The invention relates to a heptazine modified photocatalyst based on titanium dioxide that is photoactive in the visible range. The new photocatalyst permits pollutant degradation not only with artificial visible light but also with the diffuse daylight in rooms. The invention furthermore relates to a method for manufacturing a heptazine modified titanium dioxide that is effective as a photocatalyst when irradiated with visible light.

### BACKGROUND OF THE INVENTION

Photocatalysts are substances that form highly reactive oxygen radicals on their surface by absorbing light. These radicals can oxidise (mineralise) pollutants in air and water to form inorganic end products. In the case of titanium dioxide, however, this requires UV light, which accounts for only roughly 3% of sunlight. There are consequently many attempts to modify titanium dioxide in such a way that it can also utilise the main component of photochemically active sunlight, corresponding to a wavelength range from roughly 400 nm to roughly 700 nm.

Modification of this kind can essentially be accomplished in three ways. First, by doping with transition elements, such as platinum, iron, chromium and niobium. Second, by doping with main-group elements, such as nitrogen (e.g. EP 1 178 011 A1, EP 1 254 863 A1) and carbon (e.g. JP 11333304, EP 1 205 244 A1, EP 0 997 191 A1, DE 10 2004 027 549 A1). Third, by sensitisation with dyes.

The latter method is primarily used for generating electricity in photoelectrochemical cells, and there are only few reports regarding the use of such systems for oxidative elimination of pollutants in air and water. The reason for this is that most dyes are not photostable in the presence of titanium dioxide and air, likewise being degraded themselves after only brief exposure. These photocatalysts are customarily obtained by preparing a suspension of titanium dioxide in a dye solution. This results in physisorption of the dye on the surface of the solid. A characteristic example is the TiO₂/metal phthalocyanine system (metal: Fe, Cu), as reported in patent application CN 2005-10111249. These systems thus appear hardly suitable for use in technical applications.

WO 02/38272 A1 discloses the manufacture of UV photoactive transparent TiO₂ films prepared from TiO₂ precursor compounds via a sol-gel process. For improvement of the UV photoactivity and for chemical stabilisation of the films on the carrier the TiO₂ is doped by mixing an s-triazine-derivate, urea or dicyanamide to the liquid TiO₂ precursor compound. The doping imparts stability against treatment with alkalies and a higher photocatalytic activity in the ultraviolet spectral region to the photocatalytic TiO₂ film.

Y. Nosaka et al. (“Nitrogen-doped titanium dioxide photocatalysts for visible response prepared by using organic compounds”, Science and Technology of Advanced Materials 6 (2005), 143-148) disclose N-doped visible light photoactive TiO₂ photocatalysts prepared by calcining powderous TiO₂ together with guanidine carbonate, guanidine hydrochloride and urea at 350 to 550° C.

Kisch et al. (“A low-bandgap, nitrogen modified titania visible light photocatalyst”, J. of Physical Chemistry C 211 (2007) 11445-11449) report on visible light photoactive titanium dioxide which has been produced by calcining a mixture of titanium hydroxide and urea at 400° C.

### SUMMARY OF THE INVENTION

The present invention is an innovative heptazine modified photocatalyst and a method for manufacturing a photochemically and thermally stable titanium dioxide photocatalyst in which a metal-free sensitiser is bonded to the surface of the semiconductor in covalent fashion. According to the invention, a titanium compound is mixed with at least one heptazine derivate or oligo-heptazine derivate or with at least one precursor of a heptazine derivate or an oligo-heptazine derivate and subjected to thermal treatment at temperatures of about 300 to about 500° C., preferably at about 400° C. The TiO₂ photocatalyst is also referred to as TiO₂—(N═C)ₓ below. As used herein, heptazine derivate includes oligo-heptazine derivate. In this context, the expression “(N═C)ₓ” symbolises oligonuclear azine compounds, where x is a positive integer. When necessary, the precursor compound of the (oligo-)heptazine derivate is also added to this acronym, e.g. melamine (TiO₂—(N═C)ₓ/melamine). The TiO₂—(N═C)ₓ photocatalyst obtained in this way is characterised in that it degrades pollutants with visible light (λ>400 nm).

### BRIEF DESCRIPTION OF THE DRAWINGS

FIG. 1 shows the images of TiO₂—(N═C)ₓ/melamine (Example 1) obtained by transmission electron microscopy at different resolutions.

FIG. 2 shows the Kubelka-Munk function F(R_{∞}), which is proportional to the relative absorbance, as a function of wavelength (reflectance spectrum). In contrast to unmodified titanium dioxide (curve a, Reference Example) and the residue remaining after extraction (curve c), TiO₂—(N═C)ₓ/melamine (curve b, Example 1) absorbs in the visible spectral range.

FIG. 3 shows the XPS spectrum of TiO₂—(N═C)ₓ/melamine (Example 1). The asymmetric and very broad band can be described by two bands at 400.5 and 399.2 eV.

FIG. 4A shows a proposed structure for melem-based heptazine derivate modified titanium dioxide and FIG. 4B shows a proposed structure for melon-based oligo-heptazine derivate modified titanium dioxide.

FIG. 5 describes the extraction of cyameluric acid by boiling TiO₂—(N═C)ₓ/melamine (Example 6) with lye.

FIG. 6 contains reflectance spectra, from which it can be seen that, in contrast to TiO₂ (curve a, Reference Example), the melem/melon mixture (curve b) and the TiO₂—(N═C)ₓ/melem, melon produced from it (curve c, Example 4) absorb in the visible spectral range (λ≧400 nm).

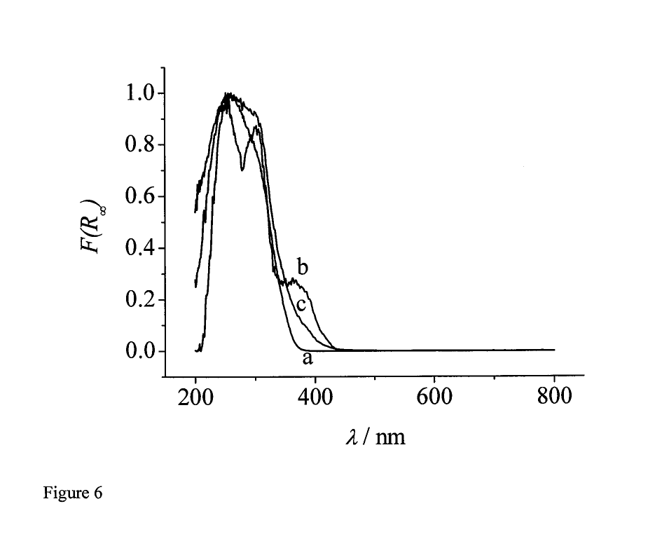

FIG. 7 shows the change in the photovoltage as a function of the pH value of the powder suspension. The inflection point can be used to determine the quasi-Fermi potential, which can be approximately equated with the lower edge of the conduction band. It can be seen that TiO₂—(N═C)ₓ/melamine (curve c, Example 1) and TiO₂—(N═C)ₓ/cyanuric acid (curve b, Example 2) have the same Fermi potential which, however, differs substantially from that of unmodified titanium dioxide (curve a, Reference Example). The corresponding values are compiled in Table 1.

FIG. 8 illustrates the photocatalytic effectiveness of TiO₂—(N═C)ₓ compared to unmodified TiO₂ (Reference Example) in the degradation of formic acid (c=1×10⁻³ mol l⁻¹ in water) by artificial visible light (λ≧455 nm). It shows the relative decrease in the formic acid concentration as a function of exposure time (c₀, cₜ correspond to the concentrations at times 0 and t); (a) TiO₂ (Sachtleben Hombikat UV-100 (Reference Example), (b) TiO₂—(N═C)ₓ/cyanuric acid, NH3 (Example 3), (c) TiO₂—(N═C)ₓ/melamine (Example 1), (d) TiO₂—(N═C)ₓ/melem, melon (Example 4). While degradation after 3 hours is only approximately 3% in the case of the unmodified TiO₂ (Reference Example) it increases to between 70% and 90% as a result of heptazine modification.

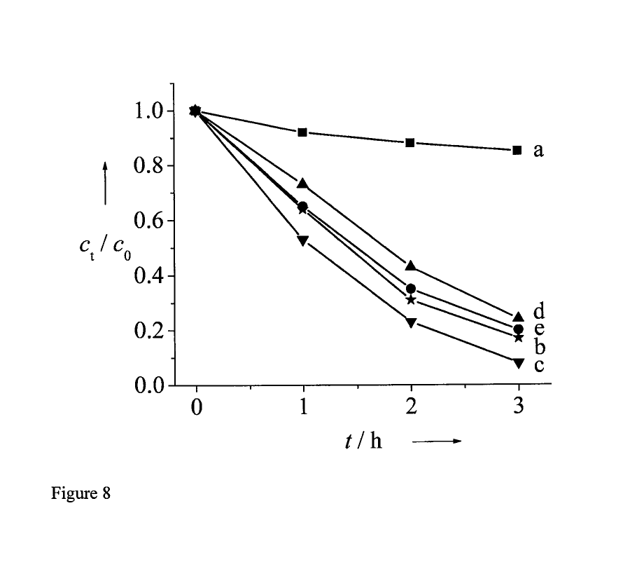

FIGS. 9a-9c illustrate structures for heptazine and heptazine derivates.

### DESCRIPTION OF THE PREFERRED EMBODIMENTS

### Product

The TiO₂—(N═C)ₓ according to the invention possesses greater photocatalytic activity than the types described in the prior art. This activity is measured on the basis of the degradation of formic acid by a defined quantity of TiO₂—(N═C)ₓ during 120-minute irradiation with light having a wavelength ≧455 nm. The nitrogen content is 0.70% to 2.50% by weight, referred to titanium dioxide, preferably 0.70% to 2.20% by weight, and particularly preferably 0.60% to 1.90% by weight. The carbon content is in the range from 0.10% to 2.00% by weight, referred to TiO₂, preferably 0.30% to 1.50% by weight, and particularly preferably 0.50% to 1.20% by weight. The hydrogen content is 0.50% to 2.00% by weight, referred to TiO₂, preferably 0.50% to 1.50% by weight, and particularly preferably 0.80% to 1.20% by weight.

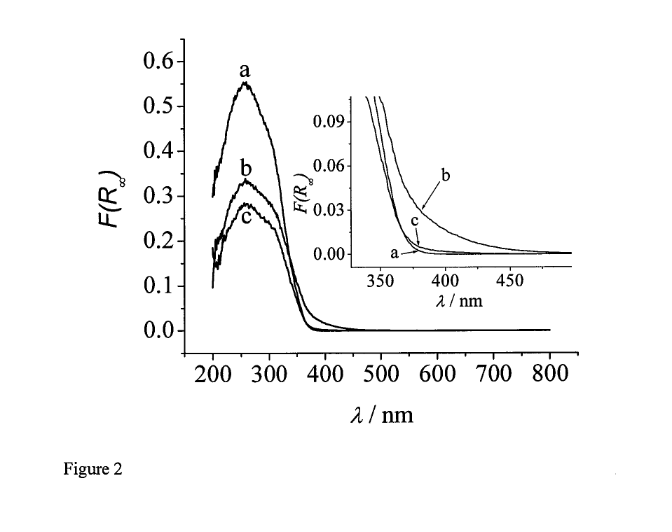

In contrast to unmodified TiO₂, the TiO₂—(N═C)ₓ according to the invention absorbs visible light with a wavelength of λ≧400 nm (FIG. 2).

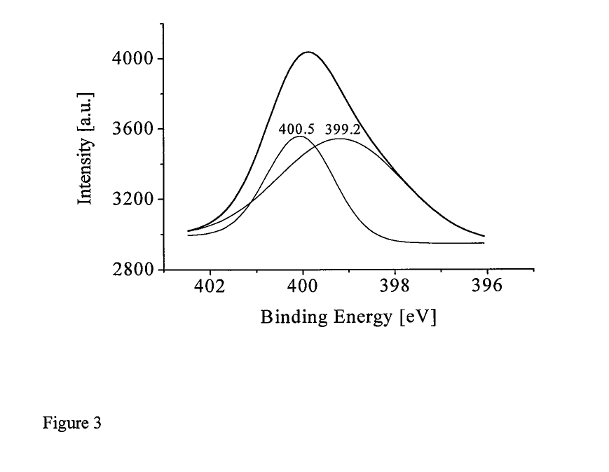

The X-ray photoelectron spectrum (XPS) of TiO₂—(N═C)ₓ is characterised preferably by the occurrence of an absorption band at a bonding energy of about 400.0 eV, referred to the O1s band at 530 eV (FIG. 3).

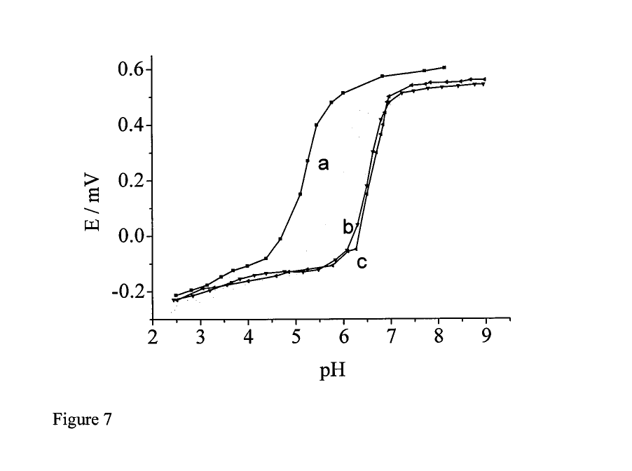

The TiO₂—(N═C)ₓ according to the invention preferably displays a quasi Fermi potential of −0.45 to −0.52 V (rel. to NHE) at pH 7 (FIG. 7).

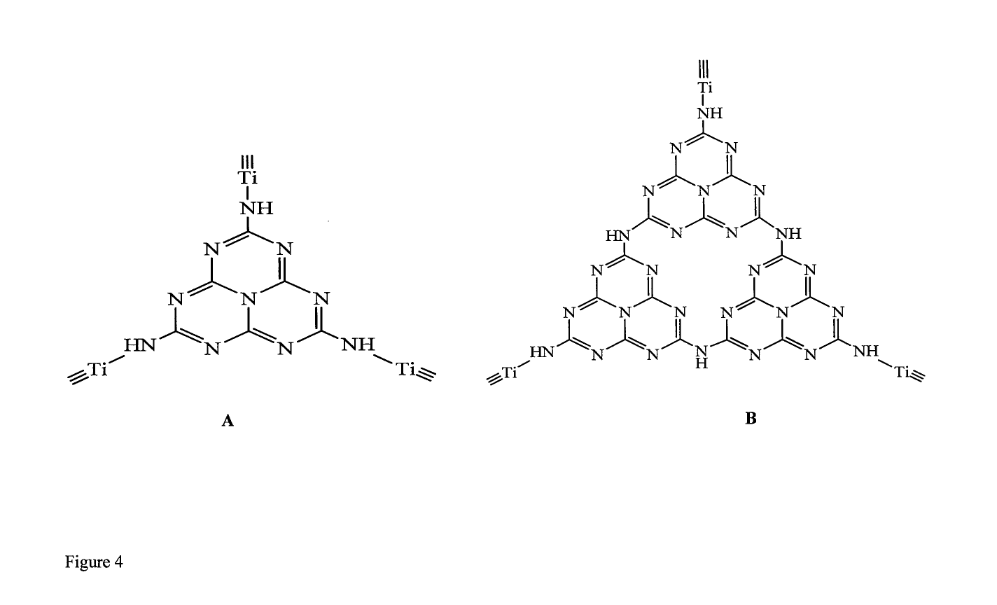

A surface layer of the titanium dioxide particles contains a heterocyclic aromatic compound of the heptazine derivate or oligo-heptazine derivate type, which is bonded to the titanium dioxide probably in covalent fashion via Ti—N bonds (FIG. 4). Heptazine (Tri-s-triazine) has the total formula C₆H₃N₇. In the present context oligo-heptazine is understood to be included in the definition of heptazine derivate and is a polycondensate with 2 to 100 heptazine cores. The heterocyclic compound can be extracted from the surface by treatment with lyes.

The new photocatalyst permits pollutant degradation not only with artificial visible light, but also with the diffuse daylight in rooms. It can be used to degrade contaminants and pollutants in liquids or gases, particularly in water and air.

The photocatalyst can advantageously be applied as a thin layer to various substrates, such as glass, wood, fibres, ceramics, concrete, building materials, SiO₂, metals, paper and plastics. Together with simple manufacture, this opens up application options in a variety of sectors, such as for self-cleaning surfaces in the construction, ceramics and automotive industry, or in environmental engineering (air-conditioning equipment, equipment for air purification and air sterilisation, and in water purification, particularly potable water, e.g. for antibacterial and antiviral purposes).

The photocatalyst can be used in coatings for indoor and outdoor purposes, such as paints, plasters, varnishes and glazes for application to masonry, plaster surfaces, coatings, wallpapers, and wood, metal, glass or ceramic surfaces, or on components, such as composite heat insulation systems and curtain-type façcade elements, as well as in road surfacings and in plastics, plastic films, fibres and paper. The photocatalyst can moreover be used in the production of prefabricated concrete elements, concrete paving stones, roof tiles, ceramics, floor and wall tiles, wallpapers, fabrics, panels and cladding elements for ceilings and walls in indoor and outdoor areas.

Since TiO₂—(N═C)ₓ is stable in air at up to 400° C., it can be used in extrusion systems in the plastics industry. It is moreover suitable for use in photovoltaic cells and for water splitting.

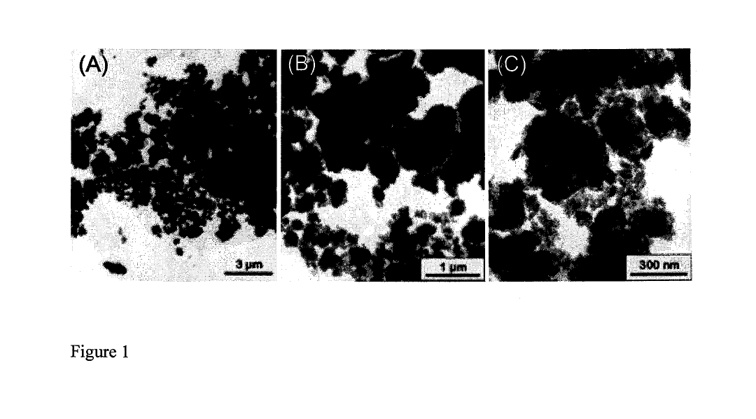

The TiO₂—(N═C)ₓ according to the invention is described in more detail below in reference to FIGS. 1 to 4.

TABLE 1
Elemental analyses of several photocatalysts in % by weight

| Photocatalyst | | N | C | H |
|---|---|---|---|---|
| TiO₂ | (Ref. Example) | — | 0.09 | 1.15 |
| TiO₂—(N═C)ₓ/CA^{a)}, NH₃ | (Example 3) | 1.78 | 0.85 | 1.16 |
| TiO₂—(N═C)ₓ/melamine | (Example 1) | 2.34 | 1.20 | 1.16 |
| TiO₂—(N═C)ₓ/melem, melon | (Example 4) | 19.41 | 10.86 | 1.89 |
| TiO₂—(N═C)ₓ/CA^{a)} | (Example 2) | 0.49 | 0.28 | 0.77 |

^{a)}Cyanuric acid

TABLE 2
N/C atomic ratios^{a)}, quasi-Fermi levels (ₙE_{F}*, pH 7), band gaps
(E_{bg}) and initial rates of mineralisation (rᵢ) of formic acid for various TiO₂—(N═C)ₓ
photocatalysts.

| | | | E_{bg} | ₙE_{F}* | rᵢ |
|---|---|---|---|---|---|
| Photocatalyst | | N/C | (eV) | (V, NHE) | (10⁻⁴ mol l⁻¹ s⁻¹) |
| TiO₂ | (Ref. Example) | 0 | 3.23 | −0.56 | 0.80 |
| TiO₂—(N═C)ₓ/CA^{b)}, NH₃ | (Example 3) | 1.80 | 2.90 | −0.48 | 4.70 |
| TiO₂—(N═C)ₓ/melamine | (Example 1) | 1.67 | 3.02 | −0.48 | 2.70 |
| TiO₂—(N═C)ₓ/melem, melon | (Example 4) | 1.53 | 3.07 | −0.51 | 3.50 |
| TiO₂—(N═C)ₓ/CA^{b)} | (Example 2) | 1.50 | 3.07 | −0.51 | 3.50 |

^{a)}By elemental analysis
^{b)}Cyanuric acid

### Production

The method according to the invention consists in a titanium compound including titanium dioxide with a specific surface of at least 30 m²/g (according to BET) being mixed, preferably intimately mixed, with at least one heptazine derivate or oligo-heptazine derivate or with at least one heptazine derivate precursor or oligo-heptazine derivate precursor, referred to as an N,C compound below, and subsequently subjected to thermal treatment at about 300° C. to about 500° C., preferably at about 400° C.

The titanium compound is titanium oxide. In the following, as used herein, titanium oxide is understood to include titanium dioxide. It can be used in the form of a fine powder or a suspension. The titanium oxide may be of crystalline or semi-crystalline structure. The titanium oxide displays a specific surface of at least 30 m²/g according to BET.

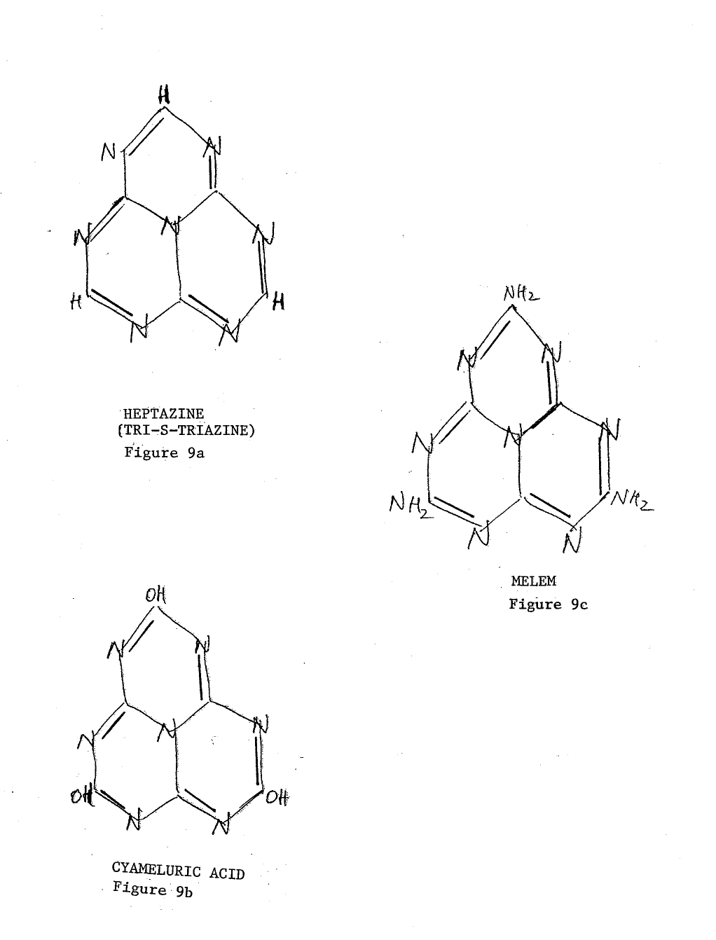

The N,C compound can be of an organic or inorganic nature and must contain carbon and nitrogen. Compounds containing functional groups, such as OH, CN, SCN, CO, CHO, COOH, NHₓ and SO₃H, have proven to be particularly suitable. Typical examples include cyanamides, thiocyanates like ammonium thiocyanate, melamine, cyanuric acid and other (N,C)ₓH precursors for heptazine derivates or oligo-heptazine derivates, as well as melem and melon, as shown in FIG. 9. The titanium compound preferably acts as a catalyst of heptazine formation.

The N,C compound can be used in the form of a solid, or a solution, or a suspension.

The titanium compound is mixed with the N,C compound in the production process. This can be done by dissolving the N,C compound in the suspension of the titanium dioxide or by mixing the suspension of the N,C compound with the suspension of the titanium compound. Intensive mixing of the N,C compound with a previously dried, powdery titanium dioxide is also possible. In the finished mixture of original titanium dioxide and N,C compound, the quantity of N,C compound referred to TiO₂ is 1% to 40% by weight. If the finished mixture is present in the form of a suspension, it can be dried by familiar methods to obtain a powdery solid before further processing.

The finished mixture is subjected to thermal treatment at temperatures of about 300 to about 500° C., preferably at about 400° C. in the presence of air or oxygen/air mixtures. This leads to the formation of heptazine derivates and/or oligo-heptazine derivates, such as melem and melon, which are bonded to the titanium dioxide surface probably via covalent Ti—N bonds (see FIG. 4). This process is preferably performed as a continuous process in heatable rotary kilns, but also in fluidised-bed reactors and fluidised-bed driers, for example.

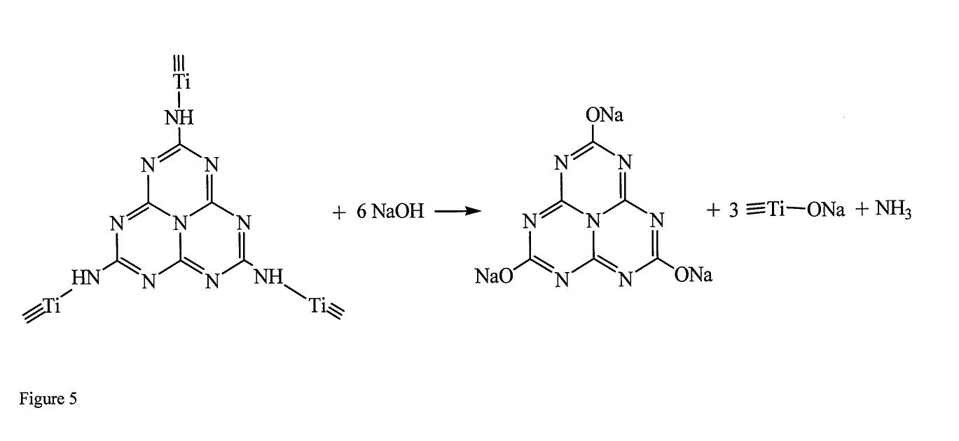

The thermal treatment is preferably performed in such a way that the product (TiO₂—(N═C)ₓ) obtained has a nitrogen/carbon ratio of 1.30 to 1.85, preferably 1.40 to 1.70, particularly preferably 1.50 to 1.65. A colour change from white to yellowish occurs in the course of thermal treatment. The end product is preferably characterised by the fact that heptazine derivates, such as cyameluric acid, can be extracted with sodium hydroxide solution (see FIG. 5). The product has a specific surface area (BET surface) of at least 30 m²/g, preferably 80 m²/g to 250 m²/g, more preferably 100 m²/g to 200 m²/g, and is photoactive in visible light.

### EXAMPLES

The invention is described in more detail on the basis of the following examples, this not being intended to restrict the scope of the invention.

### Example 1

A mixture of 1 g of commercially available titanium dioxide (Sachtleben Hombikat UV 100) with twice the quantity of melamine is ground in an agate mortar and thermally treated in an open, rotating glass flask at 400° C. for 1 hour. After cooling to room temperature, the product is washed six times, using 40 ml double-distilled water each time, and then dried at 80° C. for 1 hour.

### Example 2

Same procedure as in Example 1, the difference being that cyanuric acid is used as the N,C compound.

### Example 3

Same procedure as in Example 1, the difference being that cyanuric acid in an ammonia atmosphere is used as the N,C compound.

### Example 4

Same procedure as in Example 1, the difference being that a mixture of melem and melon is used as the N,C compound. The melem/melon mixture is prepared by tempering 5 g melamine in an open Schlenk tube at 450° C. for 5 hours.

### Example 5

As a modification of Examples 1 to 5, thermal treatment is performed in a continuously operated rotary kiln.

### Example 6

Extraction of cyameluric acid: 0.8 g TiO₂—(N═C)ₓ/melamine are refluxed overnight in 80 ml 0.01 mol l⁻¹ NaOH, and the supernatant solution is subsequently evaporated into a beige powder that is identified as cyameluric acid.

### Example 7

To coat a metal foil, a powder manufactured according to Examples 1 to 6 is suspended in a liquid, such as methanol or ethanol, using an ultrasonic bath, and the resultant suspension is applied to the foil as thinly as possible by means of a spray bottle. After subsequent drying at temperatures of up to 400° C., the procedure can be repeated until the required film thickness is reached. Other substrates can be used instead of the metal foil, e.g. paper, wood and plastic.

### Reference Example

As a reference example commercially available unmodified titanium dioxide (Sachtleben Hombikat UV 100) was used.

### Measuring Methods

a) Determination of the photoactivity (pollutant degradation) 20 ml of the powder suspension (1 g l⁻¹) in 10⁻³ mol l⁻¹ formic acid are treated in the ultrasonic bath for 15 minutes before the start of exposure. Subsequent exposure to determine the photoactivity is performed with an Osram XBO 150 W xenon short-arc lamp installed in a focusing lamp housing (AMKO, Model A1020, focal length 30 cm). The reactions are carried out in a water-cooled, 20 ml round cell with an inside diameter of 30 mm and a layer thickness of 20 mm. The reaction suspension can be stirred with a laterally mounted stirrer motor and stirring magnets. The cell is fixed at the focus of the lamp. The light is focused in such a way that only the reaction chamber of the cell is irradiated. All components are rigidly mounted on an optical bench. To eliminate UV light, a cut-off filter (Messrs. Schott) transmitting at λ≧455 nm is installed in the beam path. To prevent potential heating of the reaction chamber as a result of exposure, an IR filter is additionally fitted in the beam path. This filter is a water-filled cylinder (diameter 6 cm, length 10 cm). Samples taken are pressed through a micropore filter, and the formic acid is determined by means of ion chromatography. In no instance could oxalate be detected (Dionex DX120; column: Ion Pac 14, conductance detector; eluent: NaHCO₃/NaCO₃=0.001/0.0035 mol l⁻¹); all activity data refer to the degradation after 3-hour exposure. Initial rates were calculated from the formic acid concentrations determined after one hour. The term photoactivity is used below to denote the percentage degradation measured after 3 hours.

b) Determination of the specific surface area according to BET (Brunauer-Emmett-Teller). The BET surface is measured according to the static volumetric principle, using a Tristar 3000 from Messrs. Micromeritics.

c) XPS measurements

The bonding energies were measured using a Phi 5600 ESCA spectrometer (pass energy of 23.50 eV; Al standard; 300.0 W; 45.0°).

d) Measurement of the reflectance spectra (Kubelka-Munk function) The reflectance spectra of the powders were measured using a Shimadzu UV-2401 PC UV/V is spectrometer equipped with an Ulbricht sphere. The white standard used was barium sulphate, with which the powders were ground in a mortar before measurement. The Kubelka-Munk function is proportional to the absorbance.

1. A heptazine modified photocatalyst based on titanium dioxide
comprising at least one heptazine derivate on the titanium dioxide surface and wherein said photocatalyst displays a light absorption in the range of λ≧400 nm.

2. The photocatalyst of claim 1, wherein said heptazine derivate is an oligo-heptazine derivate.

3. The photocatalyst of claim 1, further possessing a quasi-Fermi potential of −0.45 V to −0.52 V (relative to NHE) at pH 7

4. The photocatalyst of claim 1, further having a band at a bonding energy of about 400.0 eV in the X-ray photoelectron spectrum (XPS), referred to the O1s band at 530 eV.

5. The photocatalyst of claim 1 further wherein
at least one heptazine derivate can be extracted by treatment with a lye.

6. The photocatalyst of claim 1 further having
photoactivity of at least 20%.

7. The photocatalyst of claim 1 comprising a nitrogen content of from 0.70% to 2.50% by weight, referred to titanium dioxide.

8. The photocatalyst of claim 1 further comprising a carbon content from 0.10% to 2.00% by weight, referred to TiO₂.

9. The photocatalyst of claim 1 comprising a hydrogen content from 0.50% to 2.00% by weight, referred to TiO₂,

10. The photocatalyst of claim 1, wherein the specific surface area according to BET is at least 30 m²/g.

11. A method for manufacturing a heptazine modified photocatalyst based on titanium dioxide that displays a light absorption in the range of λ≧400 nm; comprising
mixing titanium oxide, having a specific surface area of at least 30 m²/g according to BET, with at least one heptazine compound selected from the group consisting of: heptazine derivate; oligo-heptazine derivate; heptazine derivate precursor; and oligo-heptazine derivate precursor; and
subjecting the mixture to thermal treatment at a temperature of about 300° C. to about 500° C.

12. The method of claim 11, wherein the heptazine compound has a maximum decomposition temperature of 400° C.

13. The method of claim 11 wherein the heptazine compound contains at least one functional group.

14. The method of claim 13, wherein the functional group is selected from the group consisting of: OH, CN, SCN, CO, CHO, COOH, NHₓ and SO₃H.

15. The method of claim 11 wherein the heptazine compound comprises: melamine, ammonium thiocyanate, cyanuric acid or mixtures thereof.

16. The method of claim 11 wherein the heptazine compound comprises: melem or melon or mixtures thereof.

17. The method of claim 11, wherein the titanium oxide is titanium dioxide.

18. The method of claim 11, wherein the thermal treatment is performed in a kiln designed for continuous operation.

19. The method of claim 18 wherein the kiln is a rotary kiln.

20. The method of claim 11 wherein the thermal treatment is performed in a fluidised bed.

21. The method of claim 11 wherein the thermal treatment is performed in an oxidising atmosphere.

22. The method of claim 21 wherein the oxidising atmosphere is air or an oxygen/air mixture.

23. The method of claim 11 wherein the thermal treatment takes place in the presence of ammonia.

24. The method of claim 11 further comprising applying the photocatalyst to the surface of a material selected from the group consisting of: plastic, plastic film, fibres, paper, wood and road surfacings.

25. The method of claim 11 further comprising applying the photocatalyst to material selected from the group consisting of: prefabricated concrete elements, roof tiles, ceramics, wall and floor tiles, wallpapers, fabrics, panels and cladding elements for ceilings and walls, and automotive related materials.

26. The method of claim 11 further comprising applying the photocatalyst to systems selected from the group consisting of: air-conditioning systems, air purification systems, and air sterilisation systems, water purification systems, for antibacterial and antiviral purposes.

27. The method of claim 11 comprising use of the photocatalyst in photovoltaic cells and for water splitting.
